(19) United States
(12) Patent Application Publication
(10) Pub. No.: US 2014/0230070 A1
(43) Pub. Date: Aug. 14, 2014

(54) AUDITING OF SQL QUERIES USING SELECT TRIGGERS

(71) Applicant: MICROSOFT CORPORATION, Redmond, WA (US)

(72) Inventors: Ravi Ramamurthy, Redmond, WA (US); Shriraghav Kaushik, Bellevue, WA (US); Daniel Fabbri, Ann Arbor, MI (US)

(73) Assignee: MICROSOFT CORPORATION, Redmond, WA (US)

(21) Appl. No.: 13/767,223

(22) Filed: Feb. 14, 2013

(51) Int. Cl. G06F 21/60

(52) U.S. Cl. CPC G06F 21/60
USPC 726/26

(57) ABSTRACT

SQL query auditing technique embodiments are presented that involve auditing data in a relational database accessed during execution of a SQL search query via a query execution plan to detect and report access to sensitive data. In one embodiment, a computer is used for inputting a SELECT trigger which specifies the sensitive data resident in the relational database that is to be monitored for access during execution of the SQL search query. In addition, the SELECT trigger specifies an action that is to be taken once execution of the SQL search query is completed, if sensitive data was accessed. Then, during execution of the query execution plan, access to sensitive data is monitored, and whenever such access is detected, it is reported. Next, upon completion of the execution of the SQL search query, the action specified in the SELECT trigger is performed if access to sensitive data was reported.

### BACKGROUND

Auditing is a key part of the security infrastructure in a relational database system. One of the basic functions provided by most relational database systems for data auditing is a Structured Query Language (SQL) trigger. A SQL trigger enables low-level auditing of Data Definition Language/Data Manipulation Language (DDL/DML) statements. Using triggers, a system administrator can handle important data auditing tasks such as finding update queries that change sensitive data, or maintaining a history of changes to a sensitive column, among others.

Another important class of auditing involves monitoring access by SQL queries to sensitive data in a relational database. Rather than using SQL triggers, this task is currently accomplished using an offline architecture where an audit log records all SQL queries that were executed and the analysis of whether a particular query accessed some sensitive data is carried out at a later point in time by an offline auditor.

### SUMMARY

SQL query auditing technique embodiments described herein generally involve auditing data in a relational database accessed during execution of a SQL search query via a query execution plan to detect and report access to sensitive data. In one embodiment, a computer is used for inputting a SELECT trigger which specifies the sensitive data resident in the relational database that is to be monitored for access during execution of the SQL search query. In addition, the SELECT trigger specifies an action that is to be taken once execution of the SQL search query is completed, if sensitive data was accessed. Then, during execution of the query execution plan, access to sensitive data is monitored, and whenever such access is detected, it is reported. Upon completion of the execution of the SQL search query, the action specified in the SELECT trigger is performed if access to sensitive data was reported.

Further, in one embodiment, the SELECT trigger is implemented using a strategic placement of one or more audit operators in the query execution plan. This generally involves, prior to executing the query execution plan, obtaining an audit expression from the SELECT trigger which specifies what data corresponds to the sensitive data. One or more audit operators are then generated. Each of the audit operators is capable of searching records generated by the query execution plan during its execution that flow between two different relational operators of the plan to determine if sensitive data was accessed to create the records. The generated audit operator or operators are then inserted into the query execution plan between a different pair of relational operators so as to inspect records flowing between them. Next, during execution of the query execution plan, for each audit operator, whenever the audit operator detects that the specified sensitive data was accessed to create a record that flowed between the pair of relational operators associated with the audit operator, it reports the sensitive data access to an accessed internal state associated with the SQL search query.

It should also be noted that this Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

The specific features, aspects, and advantages of the disclosure will become better understood with regard to the following description, appended claims, and accompanying drawings where:

FIG. 1 is a diagram illustrating an exemplary embodiment, in simplified form, of an auditing system framework for implementing the SQL query auditing technique embodiments described herein.

FIG. 2 is a flow diagram generally outlining one embodiment of a SQL query auditing process for auditing data in a relational database accessed during execution of a SQL search query via a query execution plan to detect and report access to sensitive data.

FIG. 3 is a diagram illustrating an exemplary embodiment, in simplified form, of an auditing system framework for implementing the SQL query auditing technique embodiments described herein that additionally employ an offline auditor.

FIG. 4 is a flow diagram generally outlining one embodiment of a SQL query auditing process that uses one or more audit operators for auditing data in a relational database accessed during execution of a SQL search query via a query execution plan to detect and report access to sensitive data.

FIG. 5 is a diagram illustrating an exemplary un-instrumented query plan.

FIG. 6 is a diagram illustrating the exemplary query plan of FIG. 5, where audit operators have been added to test for sensitive data to create an instrumented query execution plan.

FIG. 7 is a diagram illustrating an exemplary instrumented query execution plan where an audit operator has been added using a highest commutative-node placement heuristic.

FIG. 8 is a flow diagram generally outlining an implementation of the process of FIG. 2 that places one or more audit operators in the query execution plan using a highest commutative-node placement heuristic.

FIG. 9 is a diagram illustrating a pseudo code implementation of the process of FIG. 8 that places one or more audit operators in the query execution plan using the highest commutative-node placement heuristic.

FIG. 10 is a diagram depicting a general purpose computing device constituting an exemplary system for implementing SQL query auditing technique embodiments described herein.

### DETAILED DESCRIPTION

In the following description of SQL query auditing technique embodiments reference is made to the accompanying drawings which form a part hereof, and in which are shown, by way of illustration, specific embodiments in which the technique may be practiced. It is understood that other embodiments may be utilized and structural changes may be made without departing from the scope of the technique.

It is also noted that for the sake of clarity specific terminology will be resorted to in describing the SQL query auditing embodiments described herein and it is not intended for these embodiments to be limited to the specific terms so chosen. Furthermore, it is to be understood that each specific term includes all its technical equivalents that operate in a broadly similar manner to achieve a similar purpose. Reference herein to “one embodiment”, or “another embodiment”, or an “exemplary embodiment”, or an “alternate embodiment”, or “one implementation”, or “another implementation”, or an “exemplary implementation”, or an “alternate implementation” means that a particular feature, a particular structure, or particular characteristics described in connection with the embodiment or implementation can be included in at least one embodiment of the SQL query auditing technique. The appearances of the phrases “in one embodiment”, “in another embodiment”, “in an exemplary embodiment”, “in an alternate embodiment”, “in one implementation”, “in another implementation”, “in an exemplary implementation”, “in an alternate implementation” in various places in the specification are not necessarily all referring to the same embodiment or implementation, nor are separate or alternative embodiments/implementations mutually exclusive of other embodiments/implementations. Yet furthermore, the order of process flow representing one or more embodiments or implementations of the SQL query auditing technique does not inherently indicate any particular order nor imply any limitations of the technique.

### 1.0 SQL Query Auditing Technique

A key component of a database security infrastructure is an auditing system. An important class of auditing involves monitoring access to sensitive data. Structured Query Language (SQL) query auditing technique embodiments described herein generally involve establishing a new type of trigger that works with SQL SELECT queries to determine if the query accessed sensitive data. This new type of trigger, dubbed the SELECT trigger substantially expands current SQL trigger functionality.

Tracking accesses to sensitive data by SQL SELECT queries is important for many applications, such as compliance with laws like the Unites States Health Insurance Portability and Accountability Act (HIPAA) privacy rules. These rules enable every patient to demand from their health care provider the name of every entity to whom his or her information has been revealed. For example, if a patient Alice receives advertisements for diabetes tests, she can check whether her health care provider has released the information that she is at risk of developing diabetes. In order to comply with HIPAA, the health care provider is required to provide the requested information. SQL query auditing technique embodiments described herein provide a way of capturing a record of all SQL SELECT queries issued to the healthcare provider's database that accessed Alice's medical information. In general, this is done contemporaneously with the execution of each query. Of course, in the foregoing example, it is not known in advance which patient will request his or her sensitive data access record. Thus, records of sensitive data access would be captured for each patient in the database.

The use of SELECT triggers also opens up the possibility of realtime feedback on access to sensitive information. For example, this realtime feedback can be employed to find users that have accessed more than a given number of patient records with a particular disease, or to find all patient records accessed by each doctor ordered by the number of patients accessed, among others. Yet another advantageous use of the realtime feedback provided by SELECT triggers is the detection of so-called insider attacks where a wrongdoer gets information about sensitive data by running SQL queries and examining the results. Such access to sensitive data is detected and can be dealt with immediately.

### 1.1 Auditing System Framework

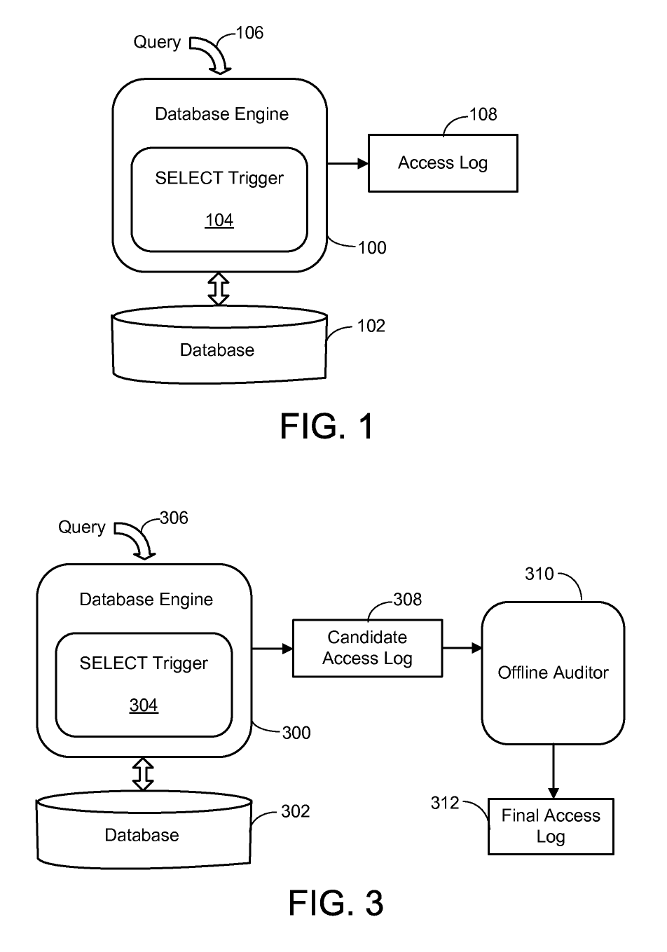

Before SQL query auditing technique embodiments are described, a general description of a suitable auditing system framework in which portions thereof may be implemented will be described. More particularly, FIG. 1 illustrates an exemplary embodiment, in simplified form, of an auditing system framework for implementing the SQL query auditing technique embodiments described herein. As exemplified in FIG. 1, the auditing system framework generally includes a database engine 100 that is in two-way communication with a relational database 102. The database engine 100 integrates the aforementioned SELECT trigger 104. As will be described in more detail shortly, a user (e.g., a system administrator) initially creates the SELECT trigger 104, which specifies the sensitive data that is to be monitored for access by a query 106 submitted to the database engine 100. The SELECT trigger 104 also specified the action to be taken once the query process is completed if sensitive data has been accessed. In the depicted auditing example of FIG. 1, this action involves recording the instances of access to the sensitive data during execution of the query in an access log 108.

### 1.2 SQL Query Auditing Process

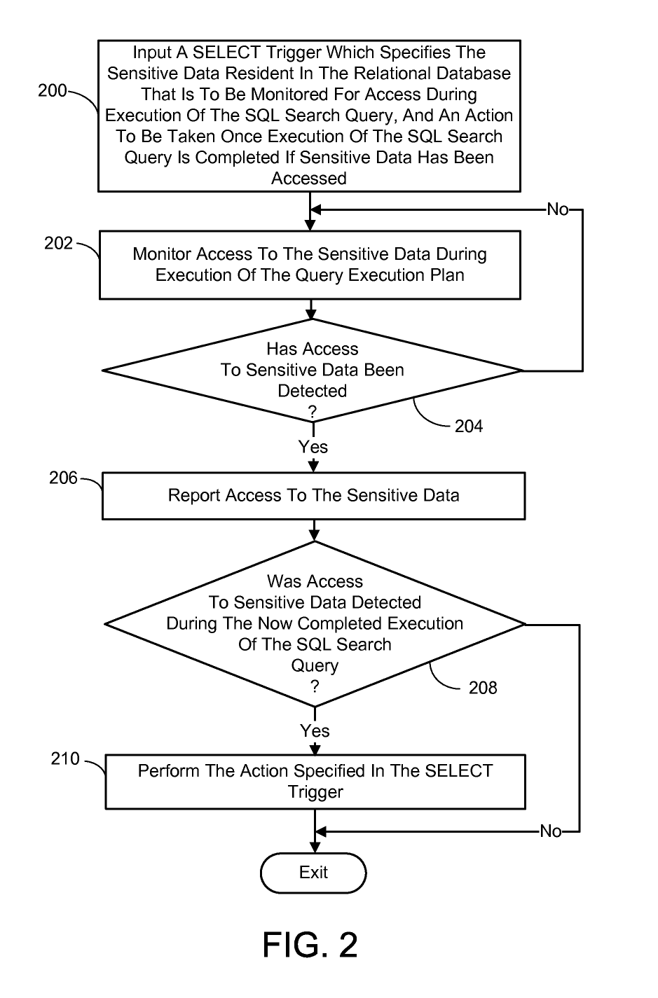

In view of the foregoing auditing system framework and in reference to FIG. 2, one general embodiment of the SQL query auditing technique embodiments described herein involves auditing data in a relational database accessed during execution of a SQL search query via a query execution plan to detect and report access to sensitive data. This is accomplished using a computer to perform the following process actions. First, a SELECT trigger is input which specifies the sensitive data resident in said relational database being monitored for access thereto during execution of the SQL search query, and an action to be taken once execution of the SQL search query is completed if sensitive data has been accessed (process action 200). Next, during execution of the query execution plan, access to the sensitive data is monitored (process action 202), and it is periodically determined if access to sensitive data has been detected (process action 204). If so, access to the sensitive data is reported (process action 206). If not, the monitoring continues. Then, upon completion of the execution of the SQL search query, it is determined if access to sensitive data has been detected during execution of the query (process action 208). If so, the action specified in the SELECT trigger is performed (process action 210).

### 1.3 SELECT Trigger Specification

Triggers are declaratively specified in a query independent manner to perform an action when specific data items are accessed. In one embodiment, the SELECT trigger is defined via the following, query-independent, specification:
on ACCESS to <SENSITIVE DATA> do <ACTION>.

During query execution, accesses to the sensitive data are recorded in the query's ACCESSED internal state. The ACCESSED internal state is a per-query, in-memory relation that maintains access information and is used by the trigger's action element. After the query completes, the action is executed. The action takes the form of an SQL (or Transact-SQL (T-SQL)) fragment and can reference the query's ACCESSED internal state. It is executed as its own system transaction. The action executes even if the query is aborted to account for queries that read a subset of the result. In addition, SELECT triggers are cascading. As a result, a SELECT trigger's action can trigger an UPDATE trigger, which in turn can trigger other SELECT triggers.

The ACCESS condition of the foregoing SELECT trigger specification refers to when data is accessed, and the SENSITIVE DATA element is specified by the user. The following sections describe what it means to access data, and one embodiment of the mechanics for specifying the sensitive data. More particularly, provenance semantics are used to determine when data is accessed, and audit expressions will be defined as a means to specify the sensitive data. In addition, the ACTION element will be described in more detail.

### 1.3.1 Data Access

The basis for data access semantics is to define what it means for a query to access a particular data record. To accomplish this task, the notion of data provenance is relied upon. In general, a data record is defined as having been accessed if it substantially contributes to the query result. More particularly, given a database instance D and a query Q, a data record (or tuple as it is sometimes referred to) t in a sensitive table T is defined as substantially contributing to the result of Q if deleting t from T changes the result.

It is noted that the notion of a tuple influencing a query is based on a definition of data provenance, namely the notion of a counter-factual record. There, the goal is to find the set of tuples τ such that after removing τ from the database, the database is in a state where inserting/removing tuple t removes tuple r from the query result. However, the notions of a counter-factual record and determining if a tuple is accessed are not identical since the interest is not in the provenance of any one output record; rather it is in finding all input records that influenced the output overall.

Before defining what it means to access data, first consider which columns are accessed by the query. A query Q accesses a set of columns if it cannot be equivalently rewritten to exclude the columns. Combining this statement with previous definition, gives the following definition for sensitive data access. Given a database instance D, a query Q, an audit expression E, a tuple t in the output of E is said to be accessed by Q if: (1) Q accesses the sensitive columns in the definition of E and (2) tuple t substantially contributes to the result of Q. It is noted that an audit expression E is a way of specifying sensitive data and will be described in more detail shortly.

Given the foregoing definition, checking if Q accesses a set of columns is straightforward. Therefore, for ease of exposition, it will be assumed heretofore that all columns in the relation underlying the audit expression are sensitive while noting that all techniques extend in a straightforward manner to allow a subset of columns to be sensitive. In the case of UPDATE and DELETE commands (which read information before modifying it), traditional trigger semantics can be relied upon to determine when data is accessed.

### 1.3.2 Audit Expression

In general, sensitive data can be any information stored in the database. A declarative approach is adopted where a user specifies what data is considered sensitive through an audit expression. Just like SQL, audit expressions provide a declarative format to specify data and the database system determines if that data is accessed. In one embodiment, audit expressions are limited to queries with simple predicates that do not involve sub-queries, and joins are limited to key-foreign key relationships. These restrictions are imposed in order to maintain the privacy guarantees of the auditing system.

Audit expressions are structured as follows in one embodiment:

CREATE AUDIT EXPRESSION <NAME> AS

SELECT <SENSITIVE COLUMNS>
FROM <TABLES T, ..., Tn>
WHERE <PREDICATE>
FOR SENSITIVE TABLE <T>,

PARTITION BY <KEY> .

An audit expression's SENSITIVE TABLE <T> element specifies the table to monitor for accesses, and the associated PARTITION BY <KEY> element specifies what information should be stored in the ACCESSED internal state (such as the tuple's primary key). The values from the partition-by key are referred to as IDs. For ease of exposition, in one embodiment, audit expressions are restricted to a single sensitive table. The sensitive columns must also be from this sensitive table.

Consider a health care database with tables Patients(PatientID, Name, Age, Zip) and Disease(PatientId, Disease). Suppose it is desired to specify that Alice's records are sensitive. This can be done using the following audit expression:

CREATE AUDIT EXPRESSION Audit_Alice AS

SELECT *
FROM Patients
WHERE Name = ‘Alice’
FOR SENSITIVE TABLE Patients,

PARTITION BY PatientID

Similarly, suppose it is desired to specify that the personal information pertaining to all patients suffering from cancer is sensitive. One way of doing so is by specifying the following expression.

CREATE AUDIT EXPRESSION Audit_Cancer AS

SELECT Patients.*
FROM Patients, Disease D
WHERE P.PatientID = D.PatientID

AND Disease = ‘cancer’

FOR SENSITIVE TABLE Patients,

PARTITION BY PatientID

### 1.3.3 Trigger Actions

There are multiple practical applications of SELECT triggers for data auditing. The simplest example is the action of writing an audit log entry for each sensitive piece of data that is accessed. Recall that the ACCESSED internal state stores information about the tuples that were accessed by the query during execution.

In one example, accesses to sensitive data associated with a patient named Alice is logged using the following:

CREATE TRIGGER Log_Alice_Accesses

ON ACCESS TO Audit_Alice AS
INSERT INTO Log
SELECT now( ), userID( ), sql( ), PatientId
FROM ACCESSED .

Here, each log entry records the time, the user who executed the query, the SQL text and PatientID that was accessed, which is Alice's ID for the given audit expression (where now( ), userID( ) and sql( ) are database methods that have access to environmental variables). The ON ACCESS TO clause specifies the audit expression (i.e., the sensitive data) and the associated attributes that are available from the ACCESSED internal state for the trigger's action (i.e., the partition-by key).

A trigger's ACTION element executes as a system transaction and retains the locks acquired by the query for the partition-by key to ensure that the recorded access information is consistent with the database state when the query was executed. However, other database states can change in the interim between the access and action executing.

In some cases, writing every PatientID may be excessive. Instead, an administrator may want to know more general information about what data is accessed. For example, suppose a database administrator wants to monitor the set of departments associated with the cancer patients whose data are accessed. This action can be expressed as follows using the existing table Departments(PatientID, DeptID):

CREATE TRIGGER Log_Cancer_Dept_Accesses

ON ACCESS TO Audit_Cancer AS
INSERT INTO Log
SELECT DISTINCT now( ), userID( ), sql( ), D.DeptID
FROM ACCESSED A, Departments D
WHERE A.PatientID = D.PatientID

Further, SELECT triggers can be combined with other triggers to produce more sophisticated systems. For example, SELECT triggers that write to the log can be combined with an INSERT trigger to automatically notify the administrator if a user accesses more than ten sensitive patients in a single day as follows:

CREATE TRIGGER Notify

ON Log AFTER INSERT AS
IF (SELECT count(DISTINCT PatientID) > 10

FROM Log
WHERE Date = NEW.Date

AND UserID = NEW.UserID)

SEND EMAIL

### 1.4 Mechanism For Select Triggers

This section outlines a mechanism to check if sensitive data is accessed in an online manner that piggybacks on query execution. In general, SQL query auditing technique embodiments described herein provide one-sided guarantees—there are no false negatives. More particularly, SELECT triggers are not allowed to produce false negatives (i.e., where a sensitive tuple is incorrectly marked as having not been accessed by a query and the SELECT trigger does not execute), otherwise accesses to sensitive data could be missed. Thus, for the class of select-join (SJ) type queries, SQL query auditing technique embodiments described herein guarantee the same result as the previously mentioned offline systems.

Furthermore, SELECT triggers implement a light-weight notion of data auditing. This light-weight approach is characterized by its efficiency and generality to audit any input query. To attain this efficiency, the possibility of false positives (i.e., where a sensitive tuple is incorrectly marked as having been accessed) is accepted for more complex queries. In one embodiment, to ensure correctness, a conventional offline system can be employed to verify all queries that are thought to access sensitive data. Even though the offline system is employed in such an embodiment, the introduction of SELECT triggers serves as a filter to reduce the number of queries and associated accesses that the offline system must audit. This can significantly reduce the offline auditing effort.

Given the foregoing, FIG. 3 illustrates an exemplary embodiment, in simplified form, of an auditing system framework for implementing the SQL query auditing technique embodiments described herein that employs an offline auditing system. This embodiment of the auditing system framework generally includes a database engine 300 that is in two-way communication with a relational database 302, as before. Likewise, the database engine 300 integrates the aforementioned SELECT trigger 304, as it did in the embodiment of FIG. 1. The user initially creates the SELECT trigger 304, which specifies the sensitive data to be monitored for access by a query 306 submitted to the database engine 300. The SELECT trigger also specified the action to be taken once the query process is completed if sensitive data has been accessed. In the depicted auditing example of FIG. 3, this action involves recording the instances of access to the sensitive data during execution of the query in a candidate access log 308. The contents of the candidate log are provided to a conventional offline auditor 310, which eliminates any false positives and then generates a final access log 312 listing the instances of access to the sensitive data during execution of the query.

### 1.4.1 Audit Operator

In one embodiment, the monitoring function of the SELECT trigger is implemented using one or more audit operators. In general, each audit operator is a logical operator similar to a data viewer that is placed between a pair of relational operators so as to intercept records flowing between them. These records, which are generated by a query execution plan during query execution, are analyzed by the audit operator to determine if sensitive data has been accessed. More particularly, an audit operator takes as input an audit expression E and determines which tuples in the output of E are accessed by the query being executed. The audit operator acts similarly to a relational filter operator in that it evaluates an IN predicate with the audit expression. The major difference from a filter operator is that instead of filtering tuples that do not satisfy the predicate, audit operators act as a no-op (i.e., they do not modify the logic of a query plan) and instead write the aforementioned partition-by information to the previously-described ACCESSED internal state. This information is then used by the SELECT trigger's ACTION clause when the query is complete. It is noted that a query execution plan that includes one or more audit operators will sometimes be referred to herein as an instrumented query plan.

### 1.4.2 SQL Query Auditing Process Using Audit Operators

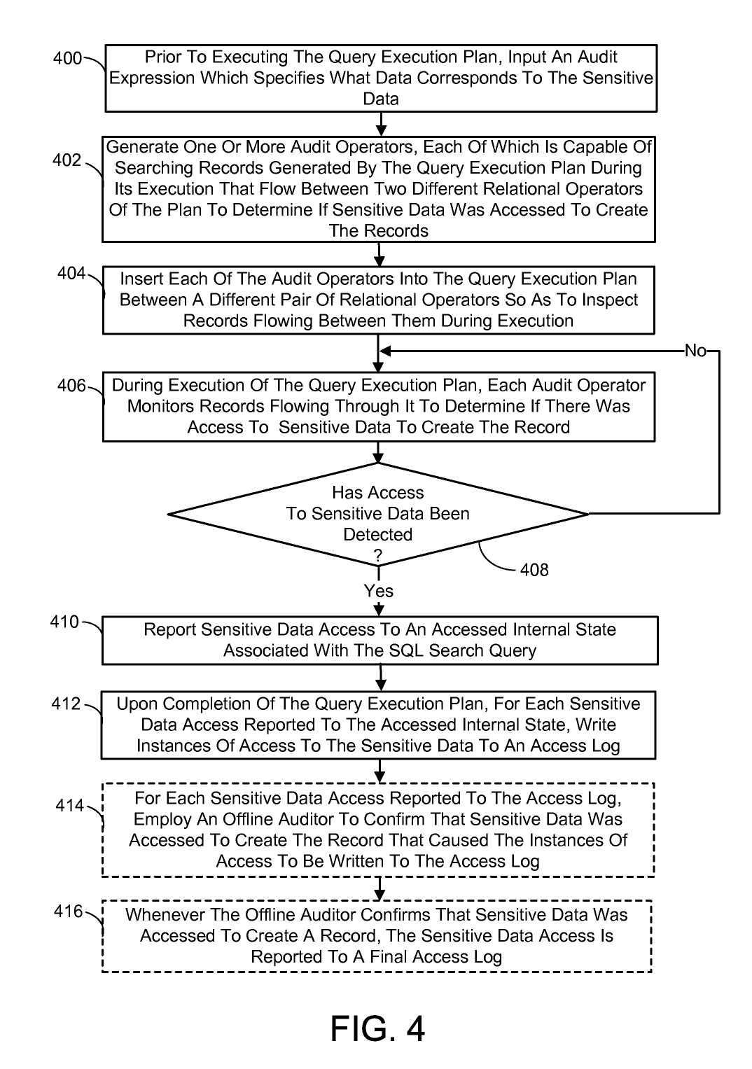

One embodiment of the SQL query auditing technique embodiments described herein that uses audit operators for auditing data during an execution of a SQL search query via a query execution plan to detect and report access to sensitive data, is as follows. Referring to FIG. 4, a computer is used prior to executing the query execution plan to input an audit expression which specifies what data corresponds to the sensitive data (process action 400). In addition, one or more audit operators are generated (process action 402). Each of the audit operators is capable of searching records generated by the query execution plan during its execution that flow between two different relational operators of the plan. The audit operators are searching for sensitive data that is accessed to create the records. Once generated, each of the audit operators is inserted into the query execution plan between a different pair of relational operators, so as to inspect records flowing between them during execution (process action 404).

The computer next performs the following process action during execution of the query execution plan. More particularly, each audit operator monitors records flowing through it to determine if there was access to sensitive data to create the record (process action 406), and it is periodically determined if access to sensitive data has been detected (process action 408). If so, access to the sensitive data is reported to an accessed internal state associated with the SQL search query (process action 410). If not, the monitoring continues. In one embodiment (shown in FIG. 4), upon completion of the query execution plan, for each sensitive data access reported to the accessed internal state, instances of access to the sensitive data during execution of the query are written in an access log (process action 412).

Further, in embodiments where a conventional offline system is employed to verify the queries that are thought to access sensitive data, the following process actions are performed after execution of the query execution plan. For each sensitive data access reported to the access log (which in this case is considered a candidate access log), an offline auditor is employed to confirm that sensitive data was accessed to create the record that caused the instances of access to be written to the candidate access log (process action 414). Whenever the offline auditor confirms that the sensitive data was accessed to create the record, the sensitive data access is reported to a final access log (process action 416). It is noted that the optional nature of process actions 414 and 416 is denoted in FIG. 4 by broken-line boxes.

### 1.4.3 Audit Operator Placement

Audit operators can be placed between any nodes in a query plan. The challenge is to place audit operators such that they do not result in false negatives and minimize the number of false positives.

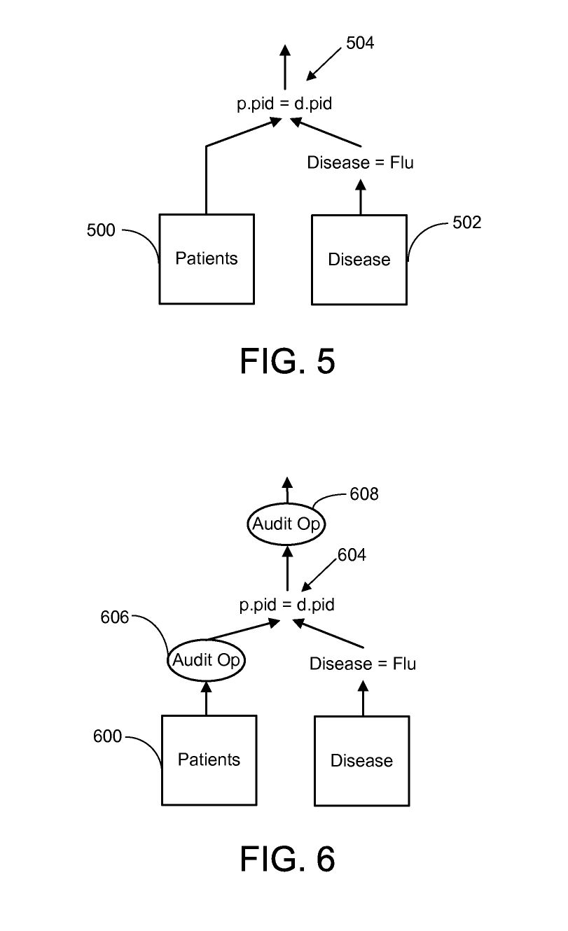

Consider the following query that is represented by the un-instrumented query plan in FIG. 5:

SELECT P.PatientID, Name, Age, Zip
FROM Patients P, Disease D
WHERE P.PatientID = D.PatientID
AND D.Disease = ‘flu’

In this query execution plan, a health care database with table Patients(PatientID, Name, Age, Zip) depicted as Patient Table 500, and table Disease(PatientId, Disease) depicted as Disease Table 502 is queried for records of patients in the Patient Table that also appear as flu patients in Disease Table. This is accomplished by determining at join operator 504 if a PatientID from Patient Table 500 matches a PatientID from Disease Table 502 (i.e., p.pid+d.pid) associated with a flu patient (i.e., Disease=Flu).

Audit operators 606, 608 can be added to the query plan to test for sensitive data at either (or both) of the edges shown in FIG. 6. If a tuple passes through an audit operator with data satisfying the audit expression, then the partition-by key is recorded in the ACCESSED internal state. For instance, consider the audit operator 606 that is placed at the output of the scan of the Patients Table 600 in FIG. 6. Assume there are two patients that satisfy the predicate (e.g., Name=Alice) but only one of them has the flu. The audit operator 606 would add the PatientIDs of both patients to the audit log thus resulting in a false positive. However, note that the audit operator 608 placed at the output of the join operator 604 would not generate this false positive.

It is noted that different audit operator placements can result in different false positive rates. However, the number of false positives is independent of the operators used in the query plan. A simple heuristic to construct an instrumented query plan with minimal false positives is to place an audit operator at the highest point in the query plan where the sensitive data is accessible. If a simplifying assumption is made that operators typically only filter rows (i.e., no cross-products, non-foreign key joins, etc.), then the highest-node heuristic ensures that the number of false positives will be minimized since its input will have the smallest cardinality among all candidate edges where the audit operator can be placed. However, as the following example demonstrates this heuristic can result in an instrumented plan that produces false positives and false negatives.

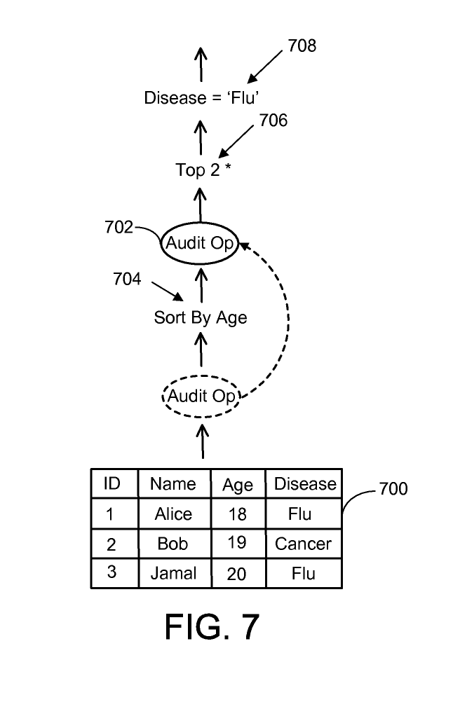

Consider a health care database and the query plan shown in FIG. 7 (sans the audit operator 702) that finds which among the two youngest patients has flu. Consider the top most edge in the plan where PatientIDs are visible (which happens to be the top of the query plan). Since Bob is among the two youngest patients and does not suffer from flu, the record corresponding to Bob does not flow past the top-most edge. Suppose that the audit expression covers all patients. If the audit operator is placed at the top-most edge, the record corresponding to Bob does not appear as part of the audit log. This leads to a false negative—the record corresponding to Bob is accessed by the above query, since deleting it changes the query result. More particularly, the output of the top-2 operator 706.

In view of the foregoing, the placement of audit operators for a single audit expression E can be characterized as follows. In this characterization, the set of partition-by IDs generated by the audit expression will be referred to as sensitiveIDs. In addition, the set of partition-by IDs generated by audit operators will be referred to as auditIDs (in the case when multiple audit operators are added to a query plan, the ACCESSED internal state contains the union of all auditIDs). Further, the set of partition-by IDs corresponding to E that are accessed by a query will be referred to as accessedIDs (as determined by the offline auditing system).

Given this, the properties of an instrumented query execution plan can be characterized as follows. An instrumented query plan for a query Q is defined to have a false positive if there exists an ID such that ID E auditIDs and ID E accessedIDs (i.e., the audit operators generate an ID that the query does not access). In addition, an instrumented query plan for a query Q is defined to have no false negatives if accessedIDs c auditIDs (i.e., every accessed ID is audited).

Thus, given a query execution plan and an audit expression E, the ideal placement of one or more audit operators to obtain an instrumented execution plan P results in P producing no false negatives, and among all instrumented plans that produce no false negatives, P has the least number of false positives. A natural heuristic for accomplishing this task would be to insert an audit operator just above the leaf level node of the sensitive table in the query execution plan (i.e., the nodes that read data from tables or indexes). If the sensitive table is instantiated multiple times (e.g., self-joins), then one audit operator is placed above each instance of the table.

The foregoing leaf-node heuristic (unlike the highest-node heuristic) generates an instrumented query plan that produces no false negatives. Consider an ID E accessed IDs. Irrespective of the choice of the query execution plan, the corresponding tuple would have been accessed at some leaf level operator in the query execution plan and thus passed as an input to the audit operator immediately above it in the plan and thus, ID E auditIDs.

While the leaf node heuristic guarantees no false negatives, this heuristic can incur a large number of false positives. For instance, in the example query plan in FIG. 6, if it is assumed that the selection predicate on the Patients table and the join predicate are independent and the join selectivity is 1%, then an audit operator placed at the output of the Patients table can result in a false positive rate of 99%.

In order to reduce the false positive rate possible with the leaf-node heuristic, the SQL query auditing technique embodiments described herein employ a new heuristic dubbed the highest commutative-node placement heuristic. In general, the highest commutative-node placement heuristic initially places an audit operator above each leaf level node associated with a sensitive table and then, for each audit operator, pulls-up the audit operators along the edges of commutative operators (e.g., selections, joins, etc.) until it lies on an edge below a non-commutative operator (such as a top-k operator), or has been moved to the top of the plan.

Because audit operators are a variation of the filter operator (but act as a no-op in the query execution plan), filter commutativity can be used to pull up the audit operator. However, we note that the highest commutative-node placement heuristic is independent of the implementation of the operator. Leveraging commutativity is useful in obtaining an instrumented query plan that produces no false negatives. For instance, consider the example query plan (sans the audit operator 702) in FIG. 7, where implementation of the highest-node heuristic would produce false negatives. This can be prevented using the highest commutative-node placement heuristic because an audit operator 702 would be initially placed above the sensitive data table 700 and only would be moved up if it was below a commutative node. In the example of FIG. 7, the “sort by age” operator 704 is commutative, and so the audit operator 702 that was initially placed above the table 700 would be moved above that node. However, the next node up (i.e., the “top 2*” operator 706) is a non-commutative top-k operator (as is the filter operator “Disease=Flu” 708 above that). Thus, the audit operator would not be moved above the “top 2*” operator and false negatives would be avoided.

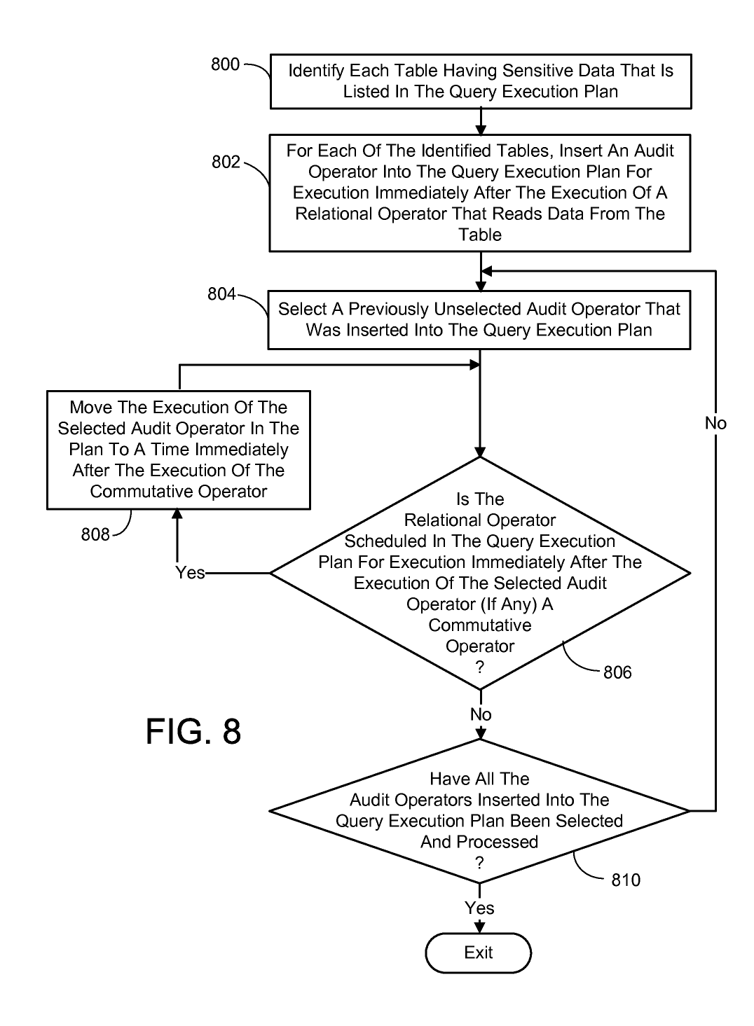

One embodiment of the SQL query auditing technique embodiments described herein places each audit operator using the highest commutative-node placement heuristic as follows. Referring to FIG. 8, each table having sensitive data that is listed in the query execution plan is identified (process action 800). For each of the identified tables, an audit operator is inserted into the query execution plan for execution immediately after the execution of a relational operator that reads data from the table (process action 802). Then, a previously unselected audit operator that was inserted into the query execution plan is selected (process action 804). It is determined if a relational operator scheduled in the query execution plan for execution immediately after the execution of the selected audit operator (if there is one) is a commutative operator (process action 806). If it is, the execution of the selected audit operator is moved in the plan to a time immediately after the execution of the commutative operator (process action 808), and process actions 806 and 808 are repeated as appropriate. But, whenever it is determined a relational operator scheduled in the query execution plan for execution immediately after the execution of the selected audit operator is not a commutative operator, then the execution order of the selected audit operator is not changed. It is next determined if all the audit operators inserted into the query execution plan have been selected and processed as described above (process action 810). If not, then process actions 804 through 810 are repeated until all the inserted audit operators have been considered for rescheduling.

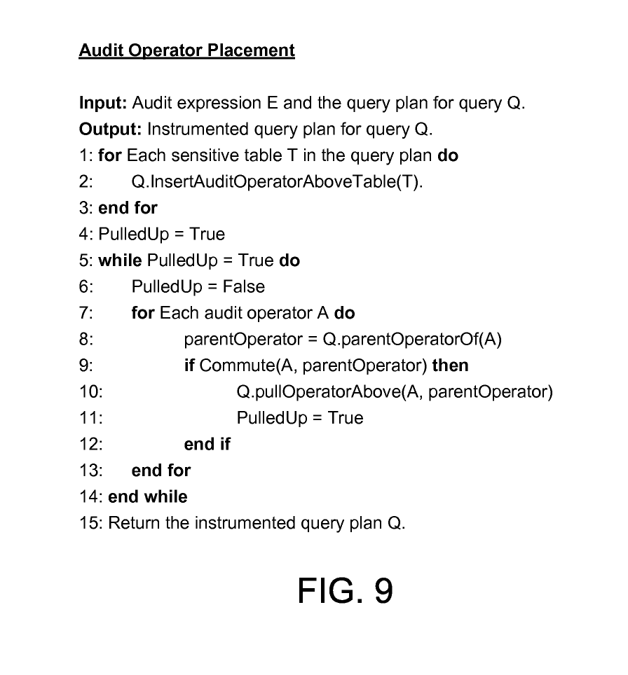

One exemplary pseudo code implementation of the foregoing highest-commutative-node heuristic is shown in FIG. 9.

It is noted that in one embodiment, all the inserted audit operators contribute to the same ACCESSED internal state records, where they are subjected to a union operation. Thus, only distinct records will be kept, with duplicate entries being eliminated. It is also noted that when multiple audit operators are inserted in a query execution plan there is a possibility that two or more of them could be moved up to the same edge below a non-commutative operator. In one embodiment, no action is taken and all the audit operators occupying the same edge contribute to ACCESSED internal state records. Alternately, if multiple instances of the same audit operator co-occupy an edge, one could be retained and the others eliminated to reduce processing, since the resulting ACCESSED internal state records would be the same no matter if the redundant audit operators are eliminated or not.

As described previously, the highest commutative-node placement heuristic places audit operators at the highest-possible edge such that it still produces a query plan with no false negatives. Higher placements typically produce fewer false positives. However, it is noted that for the class of Similarity Join (SJ) queries the instrumented query plan obtained using the highest commutative-node placement heuristic does not produce any false positives.

### 1.5 Implementation

Implementation of the SQL query auditing technique embodiments described herein generally involves implementing the audit operator and extending the query optimizer and the query execution engine to support the audit operator.

In one embodiment, the audit operator is derived from the standard filter operator. As a result it is possible to reuse most of the required modules, such as transformation rules and cost estimation to integrate the audit operator into the query optimizer. However, the audit operator's functionality is modified so that it acts as a no-op (e.g., its selectivity can be set to 1.0), and accumulates IDs in the ACCESSED internal state.

### 1.5.1 Audit Operator Implementation

One straightforward implementation of an audit operator would be equivalent to a filter operator with an IN clause that evaluates the predicate corresponding to the audit expression E and writes the partition-by IDs to the ACCESSED internal state. While this approach may be acceptable for some applications, it requires additional I/Os to access attributes that are referenced in the audit expression but are not required for query evaluation. For instance, consider an audit expression that audits for patients in a particular age group. For some queries, this attribute may not be required for evaluating the query plan. In addition, the straightforward approach requires additional CPU to propagate attributes that are referenced in the audit expression but again are not required for query evaluation.

An alternate, less I/O and CPU intensive implementation, involves a materialized view approach. In this approach the audit expression is stored as a materialized view of IDs (i.e., the partition-by key) and the audit operator checks if the corresponding IDs are present in its input stream—the set of IDs that are present are written to the ACCESSED internal state.

In the materialized view approach, when an audit expression is declared, it is stored as a materialized view of sensitiveIDs, which are maintained during updates with standard materialized view maintenance algorithms. This approach has the advantage of being able to exploit a clustered index for rowIDs often found in SQL applications. Because the partition-by key and the clustered index often coincide, compiling an audit expression to the set of corresponding keys has the advantage that in most cases it does not require any additional I/Os to read the IDs (since they are read anyway). In addition, less CPU is needed to propagate only the ID columns (note that this is independent of complexity as well as the number of attributes referenced by the audit expression's selection condition). Further, audit operator placement works for audit expressions with joins because the IDs are materialized from a single sensitive table.

Beyond the leaf level nodes, the IDs will be projected only if the operators above need them for evaluating the original query. An optimization is employed that forces the propagation of IDs in the query plan albeit at the cost of some additional CPU (of course, IDs cannot be propagated through operators such as group-by).

The audit operator essentially needs to perform an intersection between the sensitiveIDs of an audit expression and the input tuples. The audit operator accomplishes this by implementing a “hashjoin” where the hash table contains the sensitiveIDs and the hash probes are the input rows. The IDs that are joined are marked as auditIDs. It is assumed that the sensitiveIDs can fit in memory. If they cannot, standard optimizations such as bloom filters can be used instead. Because audit operators support the getNext interface, they can be placed at the output of any edge in the query execution plan. As far as the rest of query processing is concerned, an audit operator is a no-op. It outputs all input tuples, which is necessary to guarantee the correctness of the query results.

At the end of query execution, the ACCESSED internal state stores the set of auditIDs in memory. This data is then made available to the SELECT trigger's action, such as the auditIDs being written to the log.

### 1.5.2 Optimization

In one embodiment, the database query optimizer is modified to incorporate the previously-described highest commutative-node placement heuristic. Specifically, because of the foregoing audit operator implementation, the highest commutative-node placement heuristic pulls-up audit operators along edges of the query plan that commute with an IN clause on the partition by key.

Logically, audit operators do not influence the choice of the optimal query plan and therefore can be inserted into the query plan before or after optimization. However, modifying optimized query plans is more difficult because of the relative complexities of audit operators compared to logical operators. Thus, in one embodiment, the audit operators are inserted after logical optimization, but before physical optimization. This approach has the benefit that the relative positions of the operators are unlikely to change much between logical optimization and physical optimization.

Ideally, the optimizer would generate a query plan that produces the same query result as a non-instrumented optimized query plan, and maintains the correct placement of audit operators. However, because the audit operator is derived from the filter operator, optimizations can have unexpected side effects. To preclude this, the optimizer rules are extended to maintain the correct placement of audit operators in query plans, to treat audit operators as no-ops and to prevent audit operators from being optimized with non-audit operators.

### 2.0 Exemplary Operating Environments

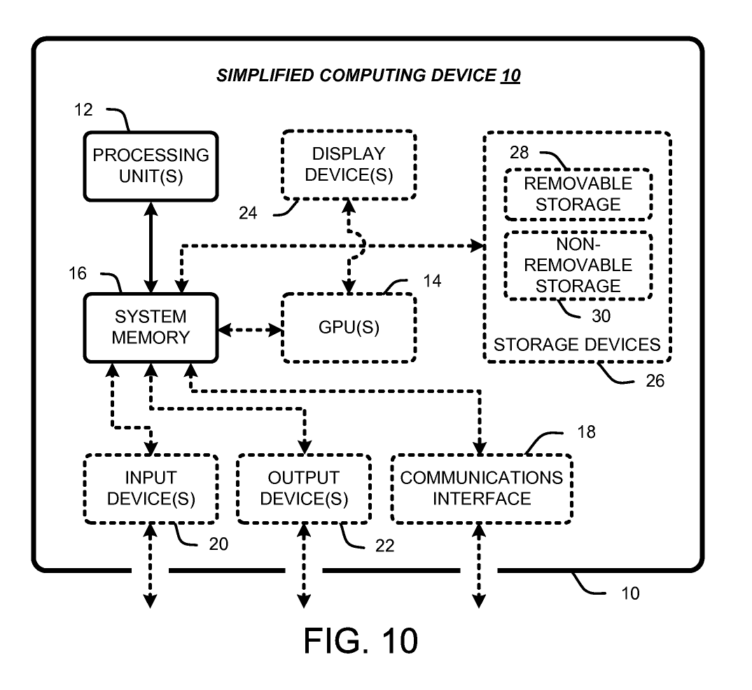

The SQL query auditing technique embodiments described herein are operational within numerous types of general purpose or special purpose computing system environments or configurations. FIG. 10 illustrates a simplified example of a general-purpose computer system on which various embodiments and elements of the SQL query auditing technique embodiments, as described herein, may be implemented. It should be noted that any boxes that are represented by broken or dashed lines in FIG. 10 represent alternate embodiments of the simplified computing device, and that any or all of these alternate embodiments, as described below, may be used in combination with other alternate embodiments that are described throughout this document.

For example, FIG. 10 shows a general system diagram showing a simplified computing device 10. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

To allow a device to implement the SQL query auditing technique embodiments described herein, the device should have a sufficient computational capability and system memory to enable basic computational operations. In particular, as illustrated by FIG. 10, the computational capability is generally illustrated by one or more processing unit(s) 12, and may also include one or more GPUs 14, either or both in communication with system memory 16. Note that that the processing unit(s) 12 of the general computing device may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 10 may also include other components, such as, for example, a communications interface 18. The simplified computing device of FIG. 10 may also include one or more conventional computer input devices 20 (e.g., pointing devices, keyboards, audio input devices, video input devices, haptic input devices, devices for receiving wired or wireless data transmissions, etc.). The simplified computing device of FIG. 10 may also include other optional components, such as, for example, one or more conventional display device(s) 24 and other computer output devices 22 (e.g., audio output devices, video output devices, devices for transmitting wired or wireless data transmissions, etc.). Note that typical communications interfaces 18, input devices 20, output devices 22, and storage devices 26 for general-purpose computers are well known to those skilled in the art, and will not be described in detail herein.

The simplified computing device of FIG. 10 may also include a variety of computer readable media. Computer readable media can be any available media that can be accessed by computer 10 via storage devices 26 and includes both volatile and nonvolatile media that is either removable 28 and/or non-removable 30, for storage of information such as computer-readable or computer-executable instructions, data structures, program modules, or other data. By way of example, and not limitation, computer readable media may comprise computer storage media and communication media. Computer storage media includes, but is not limited to, computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Retention of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer to a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying some or all of the various SQL query auditing technique embodiments described herein, or portions thereof, may be stored, received, transmitted, or read from any desired combination of computer or machine readable media or storage devices and communication media in the form of computer executable instructions or other data structures.

Finally, the SQL query auditing technique embodiments described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

### 3.0 Other Embodiments

It is noted that any or all of the aforementioned embodiments throughout the description may be used in any combination desired to form additional hybrid embodiments. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Wherefore, what is claimed is:

1. A computer-implemented process for auditing data in a relational database accessed during execution of a SQL search query via a query execution plan to detect and report access to sensitive data, comprising:
using a computer to perform the following process actions:
inputting a SELECT trigger which specifies the sensitive data resident in said relational database that is to be monitored for access during execution of the SQL search query, and an action to be taken once execution of the SQL search query is completed if sensitive data has been accessed;
during execution of the query execution plan,
monitoring for access to said sensitive data, and
whenever access to sensitive data is detected, reporting the sensitive data access; and
upon completion of the execution of the SQL search query, performing the action specified in the SELECT trigger whenever access to sensitive data was reported.

2. The process of claim 1, wherein the process action of reporting the sensitive data access, comprises an action of recording access information in an accessed internal state associated with the SQL search query.

3. The process of claim 2, wherein the process action of performing the action specified in the SELECT trigger whenever access to sensitive data was reported, comprises an action of using the recorded access information in the accessed internal state to write instances of access to the sensitive data during execution of the query in an access log.

4. The process of claim 3, wherein said access log is a candidate access log, and the process further comprising an action of providing the contents of the candidate log to an offline auditing system, which eliminates any false positives and generates a final access log listing the instances of access to the sensitive data during execution of the query.

5. The process of claim 1, wherein the process action of monitoring for access to said sensitive data, comprises an action of determining if a data record resident in a table that is designated as having sensitive data records therein has been accessed and that the accessed data record substantially contributes to the result of the query.

6. The process of claim 1, wherein the process action of inputting a SELECT trigger which specifies the sensitive data resident in said relational database, comprises an action of inputting an audit expression which specifies a table resident in the relational database that is to be monitored for access by said query, attributes of a data record resident in the specified table that are considered sensitive, and what information from the specified table is to be reported.

7. The process of claim 6, wherein the information to be reported specified in the audit expression is in the form of IDs.

8. The process of claim 1, further comprising the actions of:
prior to executing the query execution plan,
generating one or more audit operators, each of said audit operators being capable of searching records generated by the query execution plan during its execution that flow between two different relational operators of the plan for said sensitive data that is accessed to create said records, and
inserting each of the generated audit operators into the query execution plan between a different pair of relational operators so as to inspect records flowing between them.

9. The process of claim 8, wherein the process action of inserting each of the generated audit operators into the query execution plan between a different pair of relational operators so as to inspect records flowing between them, comprises the actions of:
identifying each table comprising said sensitive data listed in the query execution plan;
for each identified table, inserting an audit operator into the query execution plan for execution immediately after the execution of a relational operator that reads data from the table;
for each audit operator inserted into the query execution plan,
a) determining if a relational operator scheduled in the query execution plan for execution immediately after the execution of the audit operator, if one, is a commutative operator,
b) whenever it is determined that a relational operator scheduled in the query execution plan for execution immediately after the execution of the audit operator is a commutative operator,
moving the execution of the audit operator to a time immediately after the execution of the commutative operator, and
repeating actions a) and b).

10. A system for auditing data during execution of a SQL search query via a query execution plan to detect and report access to sensitive data, comprising:
a computing device; and
a computer program having program modules executable by the computing device, said program modules comprising,
a database engine module,
a SELECT trigger module, wherein the computing device is directed by the SELECT trigger module to receive a SELECT trigger which, specifies the sensitive data resident in a relational database that is to be monitored for access to by a query submitted to the database engine module and an action to be taken once the query process is completed if the sensitive data has been accessed.

11. The system of claim 10, wherein the action to be taken once the query process is completed if the sensitive data has been accessed comprises recording instances of access to the sensitive data during execution of the query in an access log.

12. The system of claim 11, wherein said program modules further comprise a module for providing the contents of the access log to an offline auditing system, which eliminates any false positives and generates a final access log listing the instances of access to the sensitive data during execution of the query.

13. The system of claim 10, wherein the SELECT trigger module comprises:
an audit expression module which specifies a table resident in the relational database that is to be monitored for access by said query, attributes of a data record resident in the specified table that are considered sensitive, and what information from the specified table is to be reported; and
an action module that specifies an action to be taken once the query process is completed if the sensitive data has been accessed.

14. A computer-readable storage medium having computer-executable instructions stored thereon for auditing data during execution of a SQL search query via a query execution plan to detect and report access to sensitive data, said computer-executable instructions comprising:
prior to executing the query execution plan,
inputting an audit expression which specifies what data corresponds to said sensitive data,
generating one or more audit operators, each of said audit operators being capable of searching records generated by the query execution plan during its execution that flow between two different relational operators of the plan for said sensitive data that is accessed to create said records, and
inserting each of the generated audit operators into the query execution plan between a different pair of relational operators so as to inspect records flowing between them; and
during execution of the query execution plan, for each audit operator,
whenever the audit operator detects that said sensitive data was accessed to create a record that flowed between the pair of relational operators associated therewith, the audit operator reports the sensitive data access to an accessed internal state associated with the SQL search query.

15. The computer-readable storage medium of claim 14, wherein the instruction for inserting each of the generated audit operators into the query execution plan between a different pair of relational operators so as to inspect records flowing between them, comprises an instruction for placing each audit operator using a highest commutative-node placement heuristic.

16. The computer-readable storage medium of claim 15, wherein the instruction for placing each audit operator using a highest commutative-node placement heuristic, comprises instructions for:
identifying each table comprising said sensitive data listed in the query execution plan;
for each identified table, inserting an audit operator into the query execution plan for execution immediately after the execution of a relational operator that reads data from the table;
for each audit operator inserted into the query execution plan,
a) determining if a relational operator scheduled in the query execution plan for execution immediately after the execution of the audit operator, if one, is a commutative operator,
b) whenever it is determined that a relational operator scheduled in the query execution plan for execution immediately after the execution of the audit operator is a commutative operator,
moving the execution of the audit operator to a time immediately after the execution of the commutative operator, and
repeating instructions a) and b).

17. The computer-readable storage medium of claim 16, further comprising an instruction for, whenever two or more redundant audit operators are scheduled for execution at the same time immediately after the execution of the same commutative operator, eliminating all but one of said redundant audit operators from the query execution plan prior to execution thereof.

18. The computer-readable storage medium of claim 14, further comprising an instruction for, after execution of the query execution plan, for each sensitive data access reported to the accessed internal state, writing instances of access to the sensitive data during execution of the query to an access log.

19. The computer-readable storage medium of claim 18, wherein said access log is a candidate access log, and further comprises instructions for:
employing an offline auditor to confirm that sensitive data was accessed to create the record that caused the instances of access to be written to the candidate access log; and
whenever the offline auditor confirms that said sensitive data was accessed to create said record, writing the sensitive data access to a final access log.

20. The computer-readable storage medium of claim 14, wherein all the audit operators report sensitive data accesses to the same accessed internal state associated with the SQL search query, and said instances of access to the sensitive data reported to said accessed internal state are subjected to a union operation such that duplicate reports of access are eliminated.
